(19) United States
(12) Patent Application Publication
(10) Pub. No.: US 2019/0345751 A1
(43) Pub. Date: Nov. 14, 2019

(54) PRESSURE SENSOR ASSEMBLY FOR ELEVATOR DOOR

(71) Applicant: OTIS ELEVATOR COMPANY, FARMINGTON, CT (US)

(72) Inventors: Fanping Sun, Glastonbury, CT (US); Walter Thomas Schmidt, Marlborough, CT (US); Enrico Manes, Feeding Hills, MA (US); Ziyou Xiong, Wethersfield, CT (US); Joseph V. Mantese, Ellington, CT (US); Paul R. Braunwart, Hebron, CT (US); Tadeusz Pawel Witczak, Farmington, CT (US); Goran Djuknic, New York, NY (US)

(21) Appl. No.: 15/975,489

(22) Filed: May 9, 2018

(51) Int. Cl. E05F 15/47; B66B 13/26

(52) U.S. Cl. CPC E05F 15/47; E05Y 2900/104; B66B 13/26

(57) ABSTRACT

An object sensing assembly for an elevator system. The object sensing assembly includes an elevator door moveable between an opened position and a closed position. Also included is a pressure sensor assembly located on a leading edge of the elevator door. The pressure sensor assembly includes a plurality of pressure sensors located at different height locations along the leading edge of the elevator door. The pressure sensor assembly also includes a controller in operative communication with the plurality of pressure sensors, the controller opening the elevator door if a pressure differential is detected between the plurality of pressure sensors.

### BACKGROUND

The embodiments herein relate to elevator systems and, more particularly, to a pressure sensor assembly for such systems.

Current door systems require obstruction detection in the closing door plane, leading to passengers putting hands in the door path to stop the door. As a result, some reported accidents on passenger elevators are related to door strikes and arm/finger pinch. Although the doors are usually equipped with energy radiation/reflection based obstacle detections sensors, such as light curtains or 3D radar/ultrasonic interrogation and camera systems, they may have insufficient sensitivity/resolution for small obstacles, such as fingers and dog leashes, trapped between two sliding doors. In addition, the door gap is the most likely blind spot for these sensors when the door is near full closed positions. Therefore, detection of small objects in these locations would be well received in the passenger elevator industry.

### BRIEF SUMMARY

Disclosed is an object sensing assembly for an elevator system. The object sensing assembly includes an elevator door moveable between an opened position and a closed position. Also included is a pressure sensor assembly located on a leading edge of the elevator door. The pressure sensor assembly includes a plurality of pressure sensors located at different height locations along the leading edge of the elevator door. The pressure sensor assembly also includes a controller in operative communication with the plurality of pressure sensors, the controller opening the elevator door if a pressure differential is detected between the plurality of pressure sensors.

In addition to one or more of the features described above, or as an alternative, further embodiments may include that the pressure sensor assembly further comprises a plurality of pressurized compartments located at different height locations along the leading edge of the elevator door, each of the pressurized compartments having at least one of the plurality of pressure sensors operatively coupled thereto.

In addition to one or more of the features described above, or as an alternative, further embodiments may include that each of the pressurized compartments includes at least one of the pressure sensors at an interior location of the pressurized compartments.

In addition to one or more of the features described above, or as an alternative, further embodiments may include that each of the pressurized compartments includes at least one of the pressure sensors fixed to an inner wall of the pressurized compartments.

In addition to one or more of the features described above, or as an alternative, further embodiments may include that each of the pressurized compartments is pneumatically inflated.

In addition to one or more of the features described above, or as an alternative, further embodiments may include that each pressurized compartment comprises one of a semi-circular and elliptical cross-sectional geometry.

In addition to one or more of the features described above, or as an alternative, further embodiments may include that each pressurized compartment is formed of at least one of a rubber material, polyurethane and neoprene.

In addition to one or more of the features described above, or as an alternative, further embodiments may include that the plurality of pressurized compartments are disposed in abutment along the leading edge of the elevator door.

In addition to one or more of the features described above, or as an alternative, further embodiments may include that at least two of the plurality of pressurized compartments are longitudinally spaced from each other along the leading edge of the elevator door.

In addition to one or more of the features described above, or as an alternative, further embodiments may include that the plurality of pressurized compartments are positioned along an entire height of the elevator door.

Also disclosed is an object sensing assembly for a door of a passenger compartment. The object sensing assembly includes a door moveable between an opened position and a closed position. Also included is a pressure sensor assembly located on a leading edge of the door. The pressure sensor assembly includes a plurality of pressure sensors located at different locations along the leading edge of the door. The pressure sensor assembly also includes a plurality of pressurized compartments located at different locations along the leading edge of the door, each of the pressurized compartments having at least one of the plurality of pressure sensors operatively coupled thereto. Also included is a controller in operative communication with the plurality of pressure sensors, the controller opening the door if a pressure differential is detected between the plurality of pressure sensors.

In addition to one or more of the features described above, or as an alternative, further embodiments may include that each of the pressurized compartments includes at least one of the pressure sensors at an interior location of the pressurized compartments.

In addition to one or more of the features described above, or as an alternative, further embodiments may include that each of the pressurized compartments is pneumatically inflated.

In addition to one or more of the features described above, or as an alternative, further embodiments may include that each pressurized compartment comprises one of a semi-circular and elliptical cross-sectional geometry.

In addition to one or more of the features described above, or as an alternative, further embodiments may include that each pressurized compartment is formed of at least one of a rubber material, polyurethane, and neoprene.

In addition to one or more of the features described above, or as an alternative, further embodiments may include that the plurality of pressurized compartments are disposed in abutment along the leading edge of the door.

In addition to one or more of the features described above, or as an alternative, further embodiments may include that at least two of the plurality of pressurized compartments are longitudinally spaced from each other along the leading edge of the door.

In addition to one or more of the features described above, or as an alternative, further embodiments may include that the plurality of pressurized compartments are positioned along an entire length of the door.

Further disclosed is a method of detecting objects proximate an elevator car door. The method includes comparing a plurality of pressure readings from a plurality of pressure sensors spaced along a height of the elevator car door, the pressure sensors disposed within a plurality of pressurized compartments. The method also includes opening the elevator car door if a pressure differential is detected when comparing the plurality of pressure readings.

In addition to one or more of the features described above, or as an alternative, further embodiments may include compressing at least one of the pressurized compartments to cushion an impact between the elevator car door and an object with at least one of the plurality of pressurized compartments.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 is a view of elevator doors of the elevator system having a pressure sensor assembly disposed along an edge of at least one of the elevator doors;

FIG. 3 is a perspective view of the pressure sensor assembly; and

FIG. 4 is a sectional view of the pressure sensor assembly in a first position and a second position.

### DETAILED DESCRIPTION

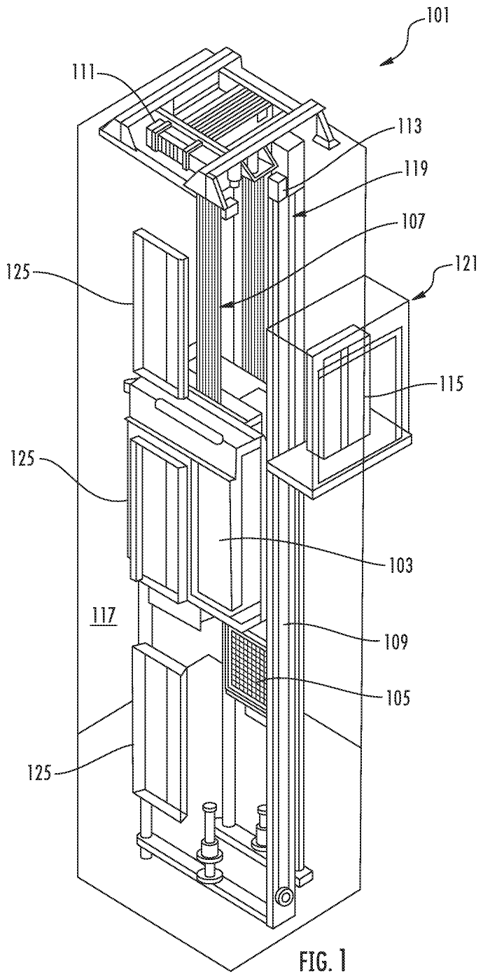

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

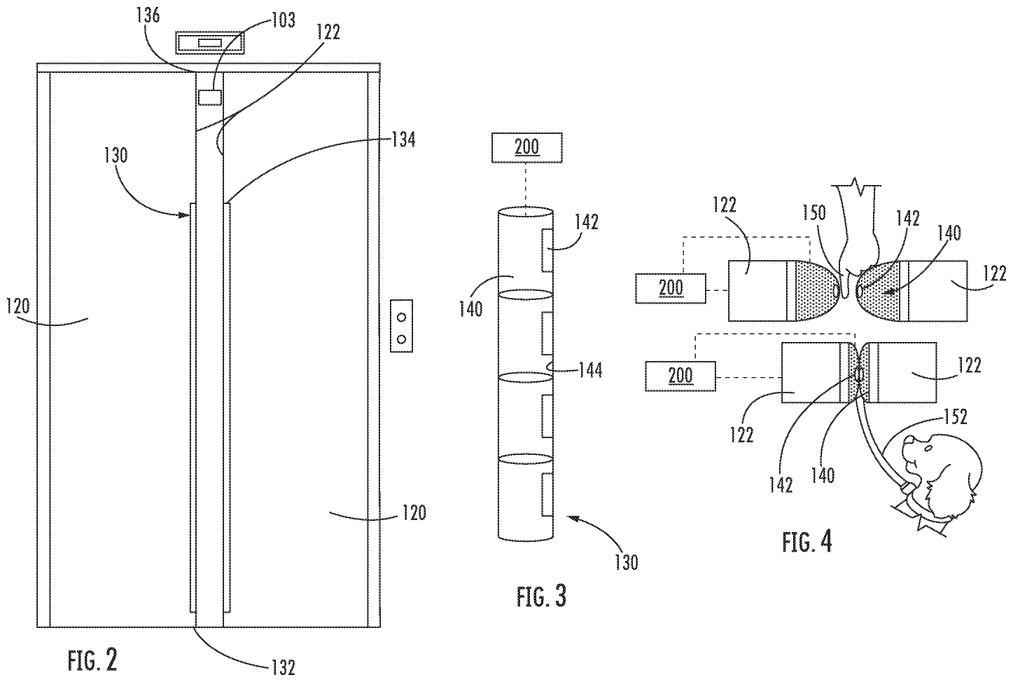

Referring now to FIG. 2, the elevator car 103 is viewed from an exterior location, such as a building lobby or floor landing area. In the illustrated embodiment, the elevator car 103 includes a pair of elevator doors 120 that may be translated between an opened position and a closed position. In such an embodiment, a respective edge 122 of each door 120 moves toward the other door during a closing action and away from the other door during an opening action. In some embodiments, a single door may be present. It is to be appreciated that the door associated with the elevator car 103 is referenced herein as the door structure that includes the sensing assembly described herein, but a landing area door may include the sensing assembly in addition to, or as an alternative to, the elevator door 120.

An object sensing assembly 130 is disclosed herein. In the illustrated two elevator door embodiment, one or both doors 120 include the object sensing assembly 130. In particular, only one of the doors 120 includes the object sensing assembly 130 in some embodiments, while both doors 120 include the object sensing assembly 130 on each door edge in other embodiments, such as the illustrated embodiment of FIG. 2. A single object sensing assembly associated with one door edge 122 will be described herein to avoid duplicative description. It is also to be appreciated that the object sensing assembly 130 may be employed on the edge 122 of a single door arrangement.

In the illustrated embodiment, the object sensing assembly 130 extends along only a portion of the door edge 122. In particular, the object sensing assembly 130 extends from a lower end 132 of the door edge 122 to a height 134 of the door edge 122 that is lower than an upper end 136 of the door edge 122. However, it is to be understood that the object sensing assembly 130 may extend along an entire height of the door edge 122 (i.e., from the lower end 132 to the upper end 136). Additionally, a continuous arrangement of the object sensing assembly 130 is shown in FIG. 2, but some embodiments may include spacing along the door edge 122 of components of the object sensing assembly 130. The precise positioning of the components of the object sensing assembly 130 may be influenced by height locations that are known to be common for impacts with objects entering or exiting the elevator car 103. For example, positions associated with human limbs—or other body parts—or dog leashes may determine positioning of the components described herein.

Referring now to FIG. 3, an illustrative arrangement of the object sensing assembly 130 is shown in more detail. In particular, the object sensing assembly 130 includes a plurality of pressurized compartments 140 and a plurality of pressure sensors 142. In the illustrated embodiment, each pressurized compartment 140 includes a single pressure sensor 142 associated therewith, but it is to be appreciated that multiple pressure sensors may be associated with each pressurized compartment 140. Each pressure sensor 142 may be operatively coupled to its respective pressurized compartment 140 in any suitable manner. For example, the pressure sensor 142 may be coupled at an interior location of the pressurized compartment 140, such as an inner wall 144 of the pressurized compartment 140.

In the embodiment of FIG. 3, the pressurized compartments 140 are substantially tubular compartments that are in abutment with an adjacent pressurized compartment. However, as described in detail above, the compartments 140 may be spaced from each other along the height of the door edge 122. In addition, the geometry of the pressurized compartments 140 may vary from that shown. For example, FIG. 4 shows a semi-tubular geometry with a semi-circular cross-section. Other suitable geometries are contemplated, with one non-limiting example being an elliptical geometry. Regardless of the particular geometry or the relative spacing from each other, the pressurized compartments 140 are inflated (e.g., pneumatically or structurally) to pressurize the interior of the pressurized compartments. The pressure level allows detection of pressure and/or deformation of the pressurized compartment, which is useful for object detection, as described herein, and also is at least partially collapsible to cushion an impact of the door edge 122 with an object, as shown in FIG. 4. The material of the pressurized compartment 140 may further cushion such an impact. For example, various soft materials may be utilized to soften the impact. For example, such materials may include rubber, polyurethane and neoprene. It is to be appreciated that various other soft materials may be suitable.

Referring now to FIG. 4, detection of an object with the object sensing assembly 130 is illustrated. A human finger 150, and more specifically a child's finger, and a dog leash 152 are shown as examples of small objects that the object sensing assembly 130 is particularly well suited to detect, although large objects would also be detected by the assembly.

The pressure level of each pressurized compartment 140 is monitored with a controller 200 that is in operative communication with the plurality of pressure sensors 142. The pressure of each compartment 140 is compared to each other. A common pressure reading indicates that an object is not being struck by the pressurized compartment 140, and therefore not being struck by the door edge 122. However, a pressure differential indicates that at least one of the pressure readings is distinct from that of the remaining compartments 140, which is indicative of an object being struck by the pressurized compartment, and therefore the door edge 122. If a pressure differential is detected, the controller 200 immediately commands the elevator door(s) 120 to move to the opened position.

The particular type of sensor employed to monitor the pressure may vary depending upon the application. In one embodiment, the pressure and deformation sensitive element can take the form of a thin film of PolyVinyliDene Fluoride (PVDF) piezoelectric. Such a material is very flexible and can conform to the soft material tube inner wall well. Due to its inverse piezoelectric effect, the PVDF piezoelectric film generates electric charge across its thickness when the inner wall is compressed along its normal direction. The charge generated by the compression of the PVDF is then converted to a voltage by a high input impedance circuit, such as analog to digital converter (ADC). Because the active nature of the piezoelectric PVDF, the sensor 142 generates the signal without need for power supply.

While the pressurized compartments 140 are described above, it is contemplated that pressure detection and monitoring may be facilitated with pressure sensors mounted to the door edge 122 itself. Additionally, although the embodiments described above pertain to an elevator door, it is contemplated that any type of automated door that opens and closes in response to passengers entering or exiting a compartment may benefit from the embodiments described herein.

The pressure sensitive assembly described herein supplements object detection efforts to the energy radiation/interrogation based 3D out of the plane door protection. When combined with the currently prevalent light curtain, it can eliminate all the causes of passage safety events, such as a finger pinch and dog leash entrapment. The assembly 130 requires minimal maintenance and no external power to operate, therefore mitigating customer call-backs.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An object sensing assembly for an elevator system comprising:
an elevator car;
an elevator door moveable between an opened position and a closed position; and
a pressure sensor assembly located on a leading edge of the elevator door, the pressure sensor assembly comprising:
a plurality of pressure sensors located at different height locations along the leading edge of the elevator door; and
a controller in operative communication with the plurality of pressure sensors, the controller opening the elevator door if a pressure differential is detected between the plurality of pressure sensors.

2. The object sensing assembly of claim 1, wherein the pressure sensor assembly further comprises a plurality of pressurized compartments located at different height locations along the leading edge of the elevator door, each of the pressurized compartments having at least one of the plurality of pressure sensors operatively coupled thereto.

3. The object sensing assembly of claim 2, wherein each of the pressurized compartments includes at least one of the pressure sensors at an interior location of the pressurized compartments.

4. The object sensing assembly of claim 3, wherein each of the pressurized compartments includes at least one of the pressure sensors fixed to an inner wall of the pressurized compartments.

5. The object sensing assembly of claim 2, wherein each of the pressurized compartments is pneumatically inflated.

6. The object sensing assembly of claim 2, wherein each pressurized compartment comprises one of a semi-circular and elliptical cross-sectional geometry.

7. The object sensing assembly of claim 2, wherein each pressurized compartment is formed of at least one of a rubber material, polyurethane and neoprene.

8. The object sensing assembly of claim 2, wherein the plurality of pressurized compartments are disposed in abutment along the leading edge of the elevator door.

9. The object sensing assembly of claim 2, wherein at least two of the plurality of pressurized compartments are longitudinally spaced from each other along the leading edge of the elevator door.

10. The object sensing assembly of claim 2, wherein the plurality of pressurized compartments are positioned along an entire height of the elevator door.

11. An object sensing assembly for a door of a passenger compartment comprising:
a door moveable between an opened position and a closed position; and
a pressure sensor assembly located on a leading edge of the door, the pressure sensor assembly comprising:
a plurality of pressure sensors located at different locations along the leading edge of the door;
a plurality of pressurized compartments located at different locations along the leading edge of the door, each of the pressurized compartments having at least one of the plurality of pressure sensors operatively coupled thereto; and
a controller in operative communication with the plurality of pressure sensors, the controller opening the door if a pressure differential is detected between the plurality of pressure sensors.

12. The object sensing assembly of claim 11, wherein each of the pressurized compartments includes at least one of the pressure sensors at an interior location of the pressurized compartments.

13. The object sensing assembly of claim 11, wherein each of the pressurized compartments is pneumatically inflated.

14. The object sensing assembly of claim 11, wherein each pressurized compartment comprises one of a semi-circular and elliptical cross-sectional geometry.

15. The object sensing assembly of claim 11, wherein each pressurized compartment is formed of at least one of a rubber material, polyurethane, and neoprene.

16. The object sensing assembly of claim 11, wherein the plurality of pressurized compartments are disposed in abutment along the leading edge of the door.

17. The object sensing assembly of claim 11, wherein at least two of the plurality of pressurized compartments are longitudinally spaced from each other along the leading edge of the door.

18. The object sensing assembly of claim 11, wherein the plurality of pressurized compartments are positioned along an entire length of the door.

19. A method of detecting objects proximate an elevator car door comprising:
comparing a plurality of pressure readings from a plurality of pressure sensors spaced along a height of the elevator car door, the pressure sensors disposed within a plurality of pressurized compartments; and
opening the elevator car door if a pressure differential is detected when comparing the plurality of pressure readings.

20. The method of claim 19, further comprising compressing at least one of the pressurized compartments to cushion an impact between the elevator car door and an object with at least one of the plurality of pressurized compartments.
